(19) United States
(12) Patent Application Publication
(10) Pub. No.: US 2025/0346486 A1
(43) Pub. Date: Nov. 13, 2025

(54) PRODUCTION APPARATUS AND METHOD FOR HIGH PURITY HYDROGEN

(71) Applicant: KOREA INSTITUTE OF ENERGY RESEARCH, Daejeon (KR)

(72) Inventors: Un Ho JUNG, Daejeon (KR); Kee Young KOO, Daejeon (KR); Yong Ha PARK, Cheonan-si (KR); Ji Haeng YU, Daejeon (KR)

(73) Assignee: KOREA INSTITUTE OF ENERGY RESEARCH, Daejeon (KR)

(21) Appl. No.: 18/745,736

(22) Filed: Jun. 17, 2024

(30) Foreign Application Priority Data
May 8, 2024 (KR) 10-2024-0060432

(51) Int. Cl. C01B 3/04; B01D 53/02; B01D 53/22; C01B 3/50; C01B 3/56; H01M 8/0606; H01M 8/0662

(52) U.S. Cl. CPC C01B 3/047; B01D 53/02; B01D 53/229; C01B 3/501; C01B 3/56; H01M 8/0606; H01M 8/0687; B01D 2253/102; B01D 2253/108; B01D 2256/16; B01D 2257/102; B01D 2257/406; C01B 2203/0272; C01B 2203/0405; C01B 2203/042; C01B 2203/0465; C01B 2203/066; C01B 2203/0822; C01B 2203/085

(57) ABSTRACT

An embodiment of the present disclosure provides a production apparatus for high purity hydrogen, the production apparatus including: a decomposition reaction unit configured to decompose ammonia through ammonia decomposition reaction and discharge reaction products including hydrogen and nitrogen produced from the ammonia decomposition reaction and non-reacting ammonia; an adsorption refinement unit configured to discharge intermediate refined products by separating or removing ammonia from the reaction products; and a hydrogen separation membrane configured to discharge a high-purity hydrogen product by refining high-purity hydrogen by separating and filtering the intermediate refined products.

### BACKGROUND OF THE INVENTION

### Field of the Invention

The present disclosure relates to a production apparatus and method for high purity hydrogen based on ammonia.

### Description of the Related Art

Ammonia decomposition reaction is a reaction (NH₃→N₂+3H₂) of two ammonia molecules decomposing into one nitrogen molecule and three hydrogen molecules and needs calorie of about 46 KJ/mol as endothermic reaction. The method of producing hydrogen through such ammonia decomposition reaction is generally used to produce high purity hydrogen that is required for common gas-related industrial fields or semiconductor and LCD factories.

When hydrogen is produced through ammonia decomposition reaction, in general, heat for preheating a reaction unit, which performs the ammonia decomposition reaction, is supplied through ammonia combustion reaction in the initial start step. However, according to this method, there is a problem that a large amount of nitrogen oxides (NOₓ) are produced in the ammonia combustion process in the initial start step.

### SUMMARY OF THE INVENTION

An objective of the present disclosure is to provide a production apparatus and method for high purity hydrogen, the apparatus and method being able to minimize use of fuel gas (LNG, LPG, etc.) and suppress production of nitrogen oxides (NOₓ) while producing high purity hydrogen using ammonia.

The objectives to implement in the present disclosure are not limited to the technical problems described above, and other objects that are not stated herein will be clearly understood by those skilled in the art from the following specifications.

In order to achieve the objectives, an embodiment of the present disclosure provides a production apparatus for high purity hydrogen, the production apparatus including: a decomposition reaction unit configured to decompose ammonia through ammonia decomposition reaction and discharge reaction products including hydrogen and nitrogen produced from the ammonia decomposition reaction and non-reacted ammonia; an adsorption refinement unit configured to discharge intermediate refined products by separating or removing ammonia from the reaction products; and a hydrogen separation membrane configured to discharge a high-purity hydrogen product by refining high-purity hydrogen by separating and filtering the intermediate refined products.

In an embodiment of the present disclosure, the decomposition reaction unit may include: a cracker configured to be supplied with ammonia and discharge the reaction products by decomposing the supplied ammonia; and a combustor configured to initially heat the cracker to a preset temperature using combustion heat generated by burning fuel gas or hydrogen.

In an embodiment of the present disclosure, the production apparatus for high purity hydrogen may further include an assistant decomposition reaction unit disposed between the decomposition reaction unit and the adsorption refinement unit and configured to produce reaction products including hydrogen, nitrogen, and non-reacted ammonia by decomposing the ammonia supplied to the cracker using an electric heating type when fuel gas cannot be used.

In an embodiment of the present disclosure, the adsorption refinement unit may supply hydrogen and nitrogen remaining after separating or removing ammonia from the reaction products to the combustor, and the combustor may heat the cracker by performing combustion using the supplied hydrogen.

In an embodiment of the present disclosure, the adsorption refinement unit may separate ammonia from the reaction products using an adsorption method, desorbs the separated ammonia, and supply the desorbed ammonia to the decomposition reaction unit, and the decomposition reaction unit may produce reaction products by decomposing the ammonia supplied from the adsorption refinement unit through ammonia decomposition reaction.

In an embodiment of the present disclosure, the hydrogen separation membrane may supply a separated and refined high-purity hydrogen product to a fuel cell, and the fuel cell may be a polymer electrolyte membrane fuel cell (PEMFC) or a phosphoric acid fuel cell (PAFC).

In an embodiment of the present disclosure, the decomposition reaction unit may receive and reuse a high-purity hydrogen product remaining after being used at the fuel cell.

In an embodiment of the present disclosure, the fuel gas may be liquefied natural gas (LNG) or liquefied petroleum gas (LPG).

In an embodiment of the present disclosure, the intermediate refined product discharged through the adsorption refinement unit may include hydrogen of 72 to 77%, and the high-purity hydrogen product that has passed through the hydrogen separation membrane may include hydrogen of 95 to 99.9%.

In order to achieve the objectives, another embodiment of the present disclosure provides a production method for high purity hydrogen, the production method including: receiving and burning fuel gas by means of a combustor; receiving ammonia and discharging reaction products including hydrogen, nitrogen, and non-reacted ammonia by decomposing the supplied ammonia through ammonia decomposition reaction by means of a cracker when the cracker reaches a target temperature due to heating by the combustor; discharging intermediate refined products by separating or removing ammonia from the reaction products by means of an adsorption refinement unit; and discharging a high-purity hydrogen product by refining high-purity hydrogen by separating and filtering the intermediate refined products by means of a hydrogen separation membrane.

In an embodiment of the present disclosure, the target temperature may be 400 to 700° C., and when the cracker reaches the target temperature, supply of fuel gas from the combustor may be stopped.

In an embodiment of the present disclosure, the production method for high purity hydrogen may further include supplying, by the hydrogen separation membran, a separated and refined high-purity hydrogen product to a fuel cell, wherein the fuel cell may be a polymer electrolyte membrane fuel cell (PEMFC) or a phosphoric acid fuel cell (PAFC).

In an embodiment of the present disclosure, the production method for high purity hydrogen may further include receiving and reusing, by the cracker, a high-purity hydrogen product remaining after being used at the fuel cell.

In order to achieve the objectives, another embodiment of the present disclosure provides a production method for high purity hydrogen, the production method including: heating, by an assistant decomposition reaction unit, using electricity; supplying ammonia to a cracker when the assistant decomposition reaction unit reaches a preset temperature; discharging reaction products including hydrogen, nitrogen, and non-reacted ammonia by receiving the ammonia supplied to the cracker and decomposing the supplied ammonia through ammonia decomposition reaction by means of the assistant decomposition reaction unit; discharging intermediate refined products by separating or removing ammonia from the reaction products by means of an adsorption refinement unit; and receiving the intermediate refined products and performing combustion using the intermediate refined products by means of a combustor.

In an embodiment of the present disclosure, the production method for high purity hydrogen may further include: discharging reaction products including hydrogen, nitrogen, and non-reacting ammonia by decomposing, by the cracker, ammonia supplied from the outside when the cracker reaches a preset temperature due to combustion by the combustor; and discharging intermediate refined products by directly receiving the reaction products discharged from the cracker and separating or removing ammonia by means of the adsorption refinement unit.

In an embodiment of the present disclosure, the production method for high purity hydrogen may further include: discharging a high-purity hydrogen product by refining high-purity hydrogen by separating and filtering, by a hydrogen separation membrane, the intermediate refined products discharged from the adsorption refinement unit; and supplying, by the hydrogen separation membrane, a separated and refined high-purity hydrogen product to a fuel cell.

### BRIEF DESCRIPTION OF THE DRAWINGS

FIG. 1 and FIG. 2 are views illustrating a method of producing hydrogen in the related art;

FIG. 3 to FIG. 4 are block diagrams illustrating an operation manner of a production apparatus for high purity hydrogen according to a first embodiment of the present disclosure;

FIG. 5 to FIG. 7 are block diagrams illustrating an operation manner of a production apparatus for high purity hydrogen according to a second embodiment of the present disclosure;

FIG. 8 is a flow chart showing a production method for high purity hydrogen according to the first embodiment of the present disclosure over time; and

FIG. 9 is a flow chart showing a production method for high purity hydrogen according to the second embodiment of the present disclosure over time.

### DETAILED DESCRIPTION OF THE PREFERRED EMBODIMENTS

Hereinafter, the present disclosure is described with reference to the accompanying drawings. However, the present disclosure may be modified in various different ways and is not limited to the embodiments described herein. Further, in the accompanying drawings, components irrelevant to the description will be omitted in order to clearly describe the present disclosure, and similar reference numerals will be used to describe similar components throughout the specification.

Throughout the specification, when an element is referred to as being “connected with (coupled to, combined with, in contact with)” another element, it may be “directly connected” to the other element and may also be “indirectly connected” to the other element with another element intervening therebetween. Further, unless explicitly described otherwise, “comprising” any components will be understood to imply the inclusion of other components rather than the exclusion of any other components.

Terms used in the present disclosure are used only in order to describe specific exemplary embodiments rather than limiting the present disclosure. Singular forms are intended to include plural forms unless the context clearly indicates otherwise. It will be further understood that the terms “comprise” or “have” used in this specification specify the presence of stated features, numerals, steps, operations, components, parts, or a combination thereof, but do not preclude the presence or addition of one or more other features, numerals, steps, operations, components, parts, or a combination thereof.

Hereinafter, embodiments of the present disclosure are described in detail with reference to the accompanying drawings.

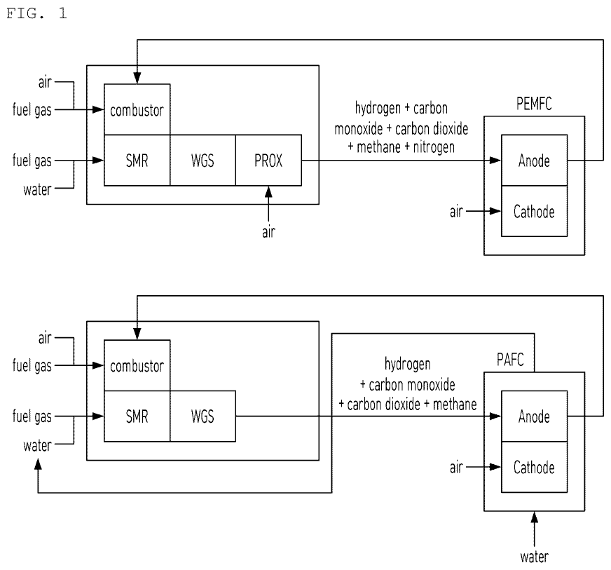

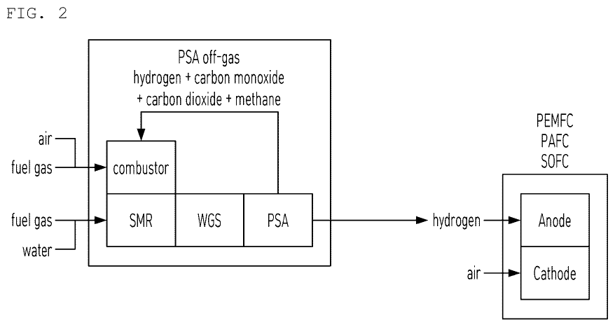

FIG. 1 and FIG. 2 are views illustrating a method of producing hydrogen in the related art.

In FIG. 1, the upper one shows a hydrogen production manner for supplying hydrogen to a polymer electrolyte membrane fuel cell (PEMFC) and the lower one is a view showing a hydrogen production manner for supplying hydrogen to a phosphoric acid fuel cell (PAFC).

In order to produce hydrogen to be supplied to a PEMFC using fuel gas (LNG, LPG, etc.), a combustor, a reformer (SMR: steam methane reforming), a water gas shift reactor (WGS), and a preferential oxidation reactor (PROX: preferential oxidation) are required.

The combustor heats the reformer (SMR) using fuel gas and air, the reformer (SMR) is supplied with fuel gas and water and produces hydrogen (H₂), carbon monoxide (CO), and carbon dioxide (CO₂) through ammonia decomposition reaction.

The WGS reactor produces hydrogen (H₂) and carbon dioxide (CO₂) by reacting carbon monoxide and water produced by the reformer (SMR).

Further, the preferential oxidation reactor (PROX) produces carbon dioxide (CO₂) by reacting carbon monoxide (CO) and air (O₂) remaining without being reacted in the WGS reactor. The PEMFC (operation temperature: about 60° C.) has a problem of carbon monoxide poisoning, so the content of carbon monoxide should be maintained at 10 ppm or less, and for this reason, the preferential oxidation reactor (PROX) should be provided.

The products finally produced through the above process and including hydrogen (H₂), carbon monoxide (CO), carbon dioxide (CO₂), methane (CH₄), and nitrogen (N₂) are supplied to the PEMFC and may include hydrogen of about 76%. When hydrogen of about 76% is supplied to the PEMFC, the efficiency of the entire fuel cell system may be derived as about 38%.

Meanwhile, in order to produce hydrogen to be supplied to a PAFC using fuel gas (LNG, LPG, etc.), a combustor, a reformer (SMR: steam methane reforming), and a WGS reactor (WGS) are required.

In the phosphoric acid fuel cell system, since the operation temperature of the PAFC is about 220° C., there is no problem of catalyst poisoning due to absorption of carbon monoxide, so there is no need for a preferential oxidation reactor (PROX) unlike the PEMFC.

Products (H₂, CO₂, CO, CH₄) produced through the reformer (SMR) and the WGS reactor are supplied to the PAFC. Since the operation temperature of the PAFC is relatively high, it can make vapor for the reformer, and accordingly, load on the combustor decreases, whereby the fuel cell system can derive efficiency of about 42%.

FIG. 2 shows another hydrogen production method for supplying hydrogen to a polymer electrolyte membrane fuel cell (PEMFC), a phosphoric acid fuel cell (PAFC), and a solid oxide fuel cell (SOFC). Referring to FIG. 1, a production apparatus for producing hydrogen needs a combustor, a reformer (SMR), a WGS reactor, and a pressure swing adsorber (PSA: pressure swing adsorption).

Hydrogen and methane are partially included in gas (PSA off gas) remaining after being refined through the reformer (SMR), the WGS reactor, and the pressure swing adsorber (PSA), so they may be reused in the reactor. Further, hydrogen refined through the pressure swing adsorber (PSA) has a purity of about 99.97% or more, thereby being able to increase the entire system efficiency.

However, the pressure swing adsorber (PSA) has defects that it consumes a large amount of energy and that a lot of cost is required when the pressure swing adsorber (PSA) is used because the reformer (SMR) and the WGS reactor should also be changed in a pressurizing type.

Production apparatus and method for high purity hydrogen of a new type for solving the problems with a fuel cell system of related art described above, and an ammonia-based high-efficiency fuel cell system including the apparatus and method are described hereafter.

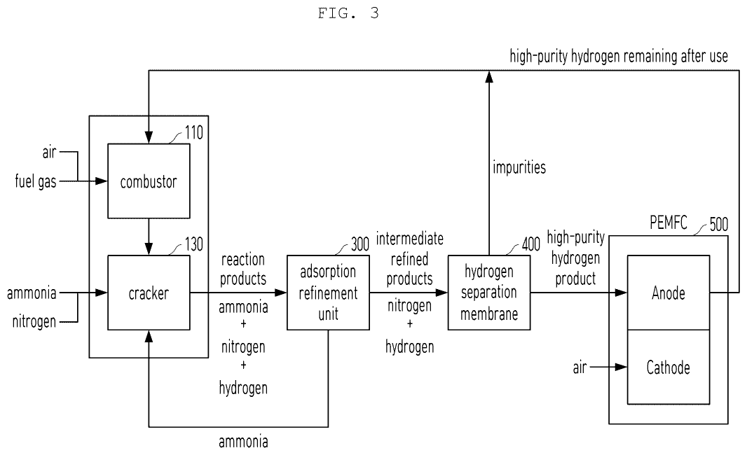

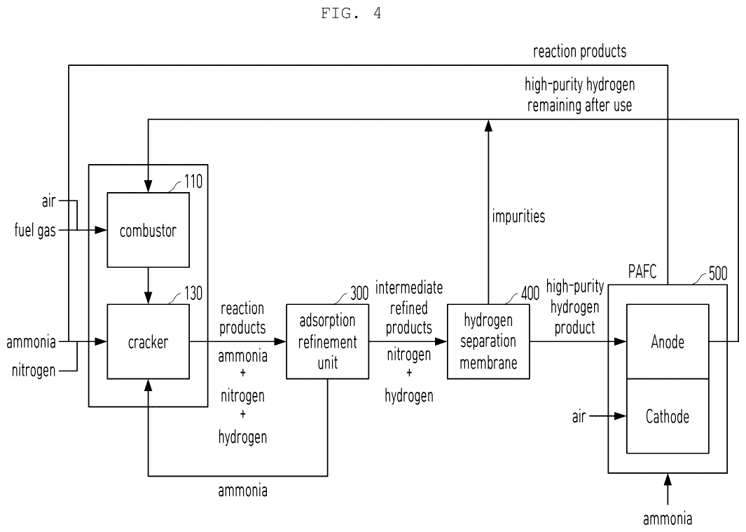

FIG. 3 to FIG. 4 are block diagram illustrating an operation manner of a production apparatus for high purity hydrogen according to a first embodiment of the present disclosure. In more detail, FIG. 3 and FIG. 4 relate to an operation manner of a production apparatus for high purity hydrogen when using fuel gas, FIG. 3 is an embodiment to which a polymer electrolyte membrane fuel cell (PEMFC) has been applied, and FIG. 4 is an embodiment to which a phosphoric acid fuel cell (PAFC) has been applied.

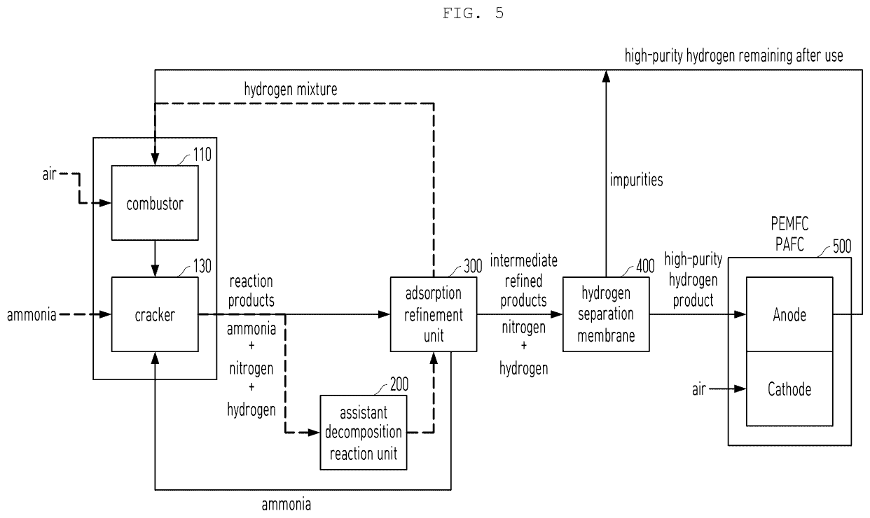

Further, FIG. 5 to FIG. 7 are block diagrams illustrating an operation manner of a production apparatus for high purity hydrogen according to a second embodiment of the present disclosure. In more detail, FIG. 5 to FIG. 7 relate to an operation manner of production apparatus for high purity hydrogen when not using fuel gas.

A production apparatus for high purity hydrogen of the present disclosure is an apparatus for producing high purity hydrogen using ammonia and may be an apparatus for producing high purity hydrogen (H₂) by decomposing ammonia (NH₃) supplied from the outside and then removing nitrogen (N₂) and non-reacted ammonia (NH₃) from decomposition reaction products.

The production apparatus for high purity hydrogen may include a decomposition reaction unit 100, an assistant decomposition reaction unit 200, an adsorption refinement unit 300, and a hydrogen separation membrane 400. Further, the fuel cell system may include a decomposition reaction unit 100, an assistant decomposition reaction unit 200, an adsorption refinement unit 300, a hydrogen separation membrane 400, and a fuel cell 500. That is, the fuel system of the present disclosure may include a production apparatus for high purity hydrogen and a fuel cell.

The decomposition reaction unit 100 can decompose ammonia through ammonia decomposition reaction and can discharge reaction products including hydrogen and nitrogen produced from the ammonia decomposition reaction and non-reacted ammonia. The decomposition reaction unit 100 may include a combustor 110 and a cracker 130.

The assistant decomposition reaction unit 200 can produce and discharge reaction products including hydrogen, nitrogen, and ammonia by decomposing supplied ammonia when fuel gas cannot be supplied. When it is difficult to supply fuel gas to the combustor 110, the assistant decomposition reaction unit 200 produces hydrogen by decomposing ammonia together with the cracker 130 and supplies the produced hydrogen to the combustor, thereby serving to enable the burning operation of the combustor. This will be described hereafter in more detail in description referring to FIG. 5.

The adsorption refinement unit 300 can discharge intermediate refined products by separating or removing ammonia from reaction products.

The adsorption refinement unit 300 can separate or remove ammonia from the reaction products using adsorption method and desorb the separated ammonia. The adsorption refinement unit 300 can supply the desorbed ammonia to the decomposition reaction unit 100. In detail, the adsorption refinement unit 300 can supply the desorbed ammonia to the cracker 130. Accordingly, the cracker 130 can produce reaction products by decomposing the ammonia supplied from the adsorption refinement unit 300 through ammonia decomposition reaction. That is, the ammonia separated or removed by the adsorption refinement unit 300 is used as the raw material of the cracker 130, so it can be reused.

The hydrogen separation membrane 400 can discharge a high-purity hydrogen product by refining high-purity hydrogen by separating and filtering the intermediate refined products.

Referring to FIG. 3, the combustor 110 can preheat the cracker 130 to a temperature for decomposing ammonia using fuel gas and air. In this case, the combustor 110 can be supplied with fuel gas from an external supplier. The combustor 110 can heat the cracker 130 using reaction heat generated by burning fuel gas using air supplied from the outside. For example, the combustor 110 may be implemented as a burner.

Fuel gas, for example, may be liquefied natural gas (LNG) or liquefied petroleum gas (LPG). As described above, by using LNG or LPG instead of ammonia that produces a large amount of NOₓ when it is burned by combustion reaction at the combustor 110, it is possible to reduce production of nitrogen oxides (NOₓ) in the initial start step (e.g., a step until the cracker reaches a steady state from the start of preheating).

Further, it is possible to prevent local heating of a reactor and derive effective thermal conduction by the combustor 110 by supplying nitrogen to the cracker 130.

Through this process, the combustor 110 can heat the cracker 130 to a preset temperature. In this case, the preset temperature may mean a temperature for reaching a steady state after ammonia decomposition reaction is started in the cracker 130 and may be measured on the basis of the internal temperature of the cracker 130. In this case, the preset temperature, for example, may be 400 to 700° C.

Through the preheating process by the combustor 110 described above, heat is gradually increased in the decomposition reaction unit 100, and when the ammonia decomposition reaction reaches a steady state (reaches a preset temperature), it is possible to stop the supply of fuel gas that has been supplied to the combustor 110 and supply of nitrogen that has been supplied to the cracker 130.

After supply of fuel gas and nitrogen is stopped, the cracker 130 can be supplied with ammonia from an external ammonia supplier.

Hereafter, ammonia decomposition reaction, an adsorption refinement process, and separating-filtering process are described.

The cracker 130 can be supplied with ammonia from an external ammonia supplier and can discharge reaction products produced by decomposing the supplied ammonia. In this case, the reaction products may include nitrogen and hydrogen produced from ammonia decomposition reaction and non-reacted ammonia. The reaction products discharged from the cracker 130 can be moved to the adsorption refinement unit 30.

The adsorption refinement unit 300 can discharge intermediate refined products by separating or removing ammonia from reaction products.

The adsorption refinement unit 300 can remove and separate ammonia from reaction products using an adsorbent. The adsorbent, for example, may be active carbon or zeolite, but is not limited thereto and may include various substances having a strong property of adsorbing gas or liquid.

As an embodiment, the adsorption refinement unit 300 may have an adsorbent therein and reaction products can pass through such adsorption refinement unit 300.

Intermediate refined products discharged through the adsorption refinement unit 300 may include only nitrogen and hydrogen or may include nitrogen, hydrogen, and a very small amount of ammonia (ammonia of 0.1 ppm or less), and the intermediate refined products may include hydrogen of 72 to 77%.

The hydrogen separation membrane 400 can discharge a high-purity hydrogen product by refining high-purity hydrogen by separating and filtering the intermediate refined products. The high-purity hydrogen product that has passed through the hydrogen separation membrane 400 may include high-purity hydrogen of 95 to 99.9%.

The hydrogen separation membrane 400 can send impurities, which are filtered out by refining the intermediate refined products, back to the combustor 110. In this case, the impurities may include nitrogen and hydrogen.

Since the hydrogen separation membrane 400 is operated at a low pressure in comparison to a pressure swing adsorber (PSA), it is possible to reduce energy consumption. For example, the hydrogen separation membrane 400 may be driven at an operation pressure of 3 atm or below and the operation temperature may be room temperature.

The hydrogen separation membrane 400 can supply the high-purity hydrogen product produced through the separating-filtering process to the fuel cell 500.

Further, the fuel cell 500 uses the high-purity hydrogen product supplied from the hydrogen separation membrane 400 and can supply the high-purity hydrogen remaining after use back to the combustor 110 (see FIG. 4). The high-purity hydrogen product provided from the hydrogen separation membrane 400 is supplied in excess in comparison to the amount of hydrogen required for the fuel cell 500, so the high-purity hydrogen product is not fully used and some remains. The remaining high-purity hydrogen not used by the fuel cell 500 can be reused at the combustor 110.

FIG. 3 described above illustrates the operation manner of a production apparatus for high purity hydrogen to which a polymer electrolyte membrane fuel cell (PEMFC) has been applied, and FIG. 4 relates to the operation manner of a production apparatus for high purity hydrogen to which a phosphoric acid fuel cell (PAFC) has been applied. The production apparatus for high purity hydrogen according to FIG. 4 is same as or similar to the production apparatus for high purity hydrogen according to FIG. 3 in configuration and operation principle, but the production apparatus is different in that it is operated in linkage with a phosphoric acid fuel cell (PAFC).

The operation temperature of the polymer electrolyte membrane fuel cell (PEMFC) is about 60° C., but the operation temperature of the phosphoric acid fuel cell (PAFC) is about 220° C., so the phosphoric acid fuel cell is operated in a relatively high-temperature environment. Referring to FIG. 4, ammonia (NH₃) is supplied to the phosphoric acid fuel cell 500, and it is possible to decompose (crack in advance) the supplied ammonia using energy (calorie) that is generated at the phosphoric acid fuel cell 500 by high-temperature operation.

In more detail, it is possible to crack in advance through an assistant cracker (not shown) that uses energy generated by heat exchanging the high-temperature cooling water, which comes out after cooling the inside of the stack of the phosphoric acid fuel cell 500. That is, the production apparatus for high purity hydrogen is possible to perform pre-cracking that performs ammonia decomposition reaction in the phosphoric acid fuel cell 500 itself, and reaction products (nitrogen, hydrogen, and non-reacted ammonia) produced by pre-cracking can be supplied to the cracker 130.

Accordingly, the cracker 130 can be supplied with reaction products produced by the phosphoric acid fuel cell 500 or can be supplied with ammonia (NH₂) from an external ammonia supplier to discharge reaction products through ammonia decomposition reaction.

Since the ammonia decomposition efficiency can be increased by pre-cracking of the phosphoric acid fuel cell 500, the production apparatus for high purity hydrogen according to this embodiment has the advantage that the entire energy efficiency increases.

Other components overlap the description of the production apparatus for high purity hydrogen described above with reference to FIG. 3, so they are not described below.

FIG. 5 to FIG. 7 are views illustrating a production apparatus and method for high purity hydrogen using only ammonia when fuel gas cannot be supplied, and the production apparatus for high purity hydrogen according to this embodiment may further include an assistant decomposition reaction unit 200.

FIG. 5 is a view illustrating an initial step (start step) of a production apparatus for high purity hydrogen.

The assistant decomposition reaction unit 200 may be connected to the rear end of the cracker 130.

The assistant decomposition reaction unit 200 may be a cracker (e-cracker) that uses an electric heating type. That is, the assistant decomposition reaction unit 200 can perform heating for ammonia decomposition reaction by itself using an electric heating type even though fuel gas is not supplied from the outside.

When the assistant decomposition reaction unit 200 reaches a preset temperature through self-heating, the assistant decomposition reaction unit 200 can produce reaction products by receiving ammonia, which is supplied to the cracker 130 at the front end, and decomposing the ammonia and can send the produced reaction products to the adsorption refinement unit 300. The adsorption refinement unit 300 can adsorb and refine the reaction products supplied from the assistant decomposition reaction unit 200. The adsorption refinement unit 300 can provide hydrogen and nitrogen remaining after ammonia is separated or removed by adsorbing and filtering the reaction products to the combustor 110.

The combustor 110 can perform combustion using hydrogen of intermediate refined products provided from the adsorption refinement unit 300 and the cracker 130 is heated by combustion by the combustor 110. Nitrogen dioxides (NOₓ) are not produced in this process.

In short, when the temperature of the assistant decomposition reaction unit 200 reaches about 500 to 700° C. after self-heating of the assistant decomposition reaction unit 200 using electricity, ammonia is supplied to the cracker 130 and the assistant decomposition reaction unit 200 can receive the ammonia supplied to the cracker 130 and produce reaction products (nitrogen and hydrogen). The combustor 110 can heat the cracker 130 to a target temperature by receiving and burning hydrogen refined by the adsorption refinement unit 300 from the reaction products produced through the assistant decomposition reaction unit 200.

That is, ammonia that is supplied to the cracker 130 in the initial state may be for operating the combustor 110.

The assistant decomposition reaction unit 200 can be operated in the initial start step and can be operated when fuel gas is not used.

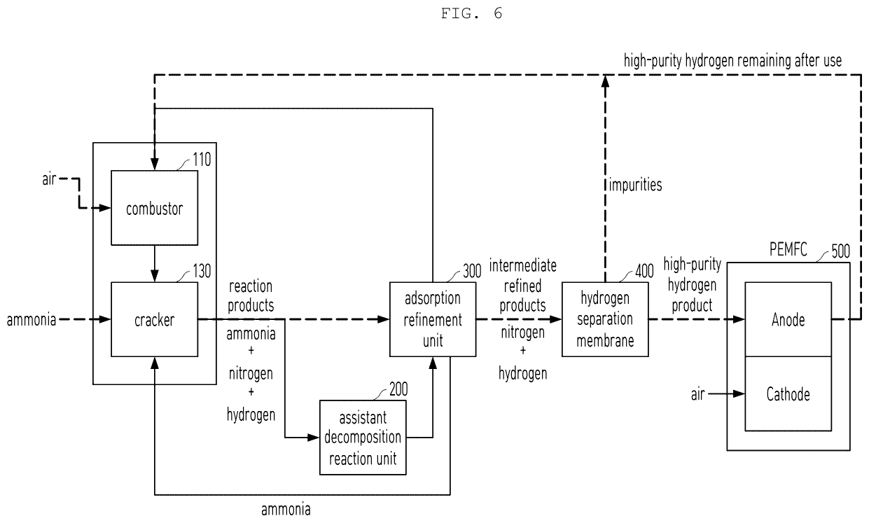

FIG. 6 shows an operation method that is performed when the cracker 130 reaches a target temperature (about 300 to 500° C.) by the combustor 110. Referring to FIG. 6, when the temperature of the cracker 130 reaches a target temperature, reaction products produced at the cracker 130 can be transferred directly to the adsorption refinement unit 300 without passing through the assistant decomposition reaction unit 200.

In this case, the movement path of the reaction products produced at the cracker 130 (the path going to the assistant decomposition reaction unit and the path going to the adsorption refinement unit) may be controlled using a valve.

The cracker 130 can produce reaction products by decomposing ammonia supplied from the outside and can transfer the produced reaction products to the adsorption refinement unit 300. The adsorption refinement process and the separating-filtering process that are performed at the adsorption refinement unit 300 and the hydrogen separation membrane 400 are substantially the same as those shown in FIG. 3, so detailed description thereof is omitted.

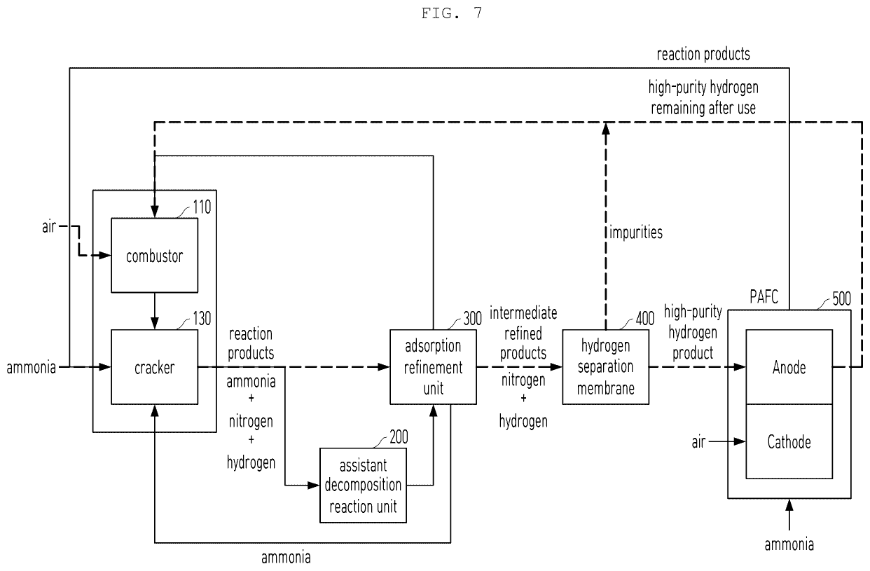

FIG. 5 described above is a manner corresponding to both of when the fuel cell 500 is a polymer electrolyte membrane fuel cell (PEMFC) and when the fuel cell 500 is a phosphoric acid fuel cell (PAFC), FIG. 6 is the case in which a polymer electrolyte membrane fuel cell (PEMFC) has been applied, and FIG. 7 is the case in which a phosphoric acid fuel cell (PAFC) has been applied. Description of FIG. 7 is the same as that of FIG. 4, so repeated description is omitted.

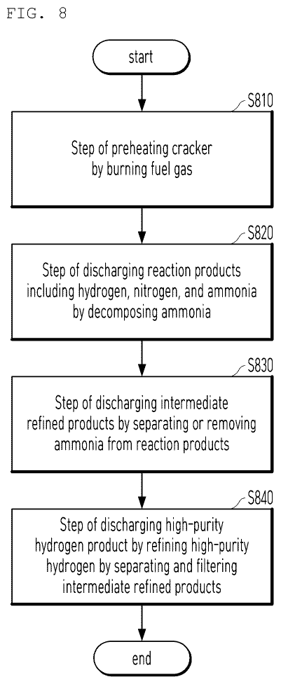

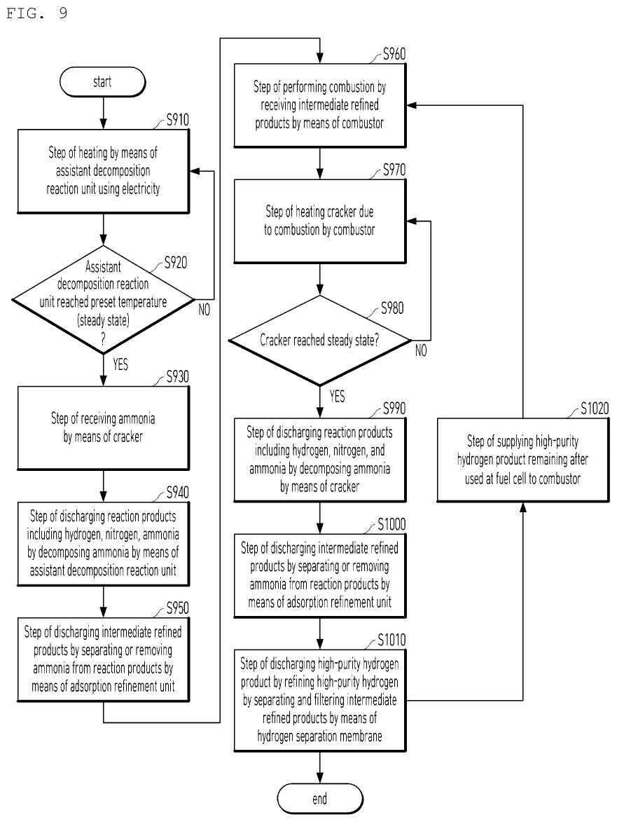

FIG. 8 is a flow chart showing a production method for high purity hydrogen according to the first embodiment of the present disclosure over time and FIG. 9 is a flow chart showing a production method for high purity hydrogen according to the second embodiment of the present disclosure over time.

Referring to FIG. 8, first in step S810, the combustor 110 can preheat the cracker 130 by burning fuel gas. The combustor 110 can heat the cracker 130 to a preset temperature by performing combustion using fuel gas. In this case, the preset temperature may be a temperature at which the cracker 130 can induce ammonia decomposition reaction.

Through the preheating process by the combustor 110 described above, heat gradually increases in the decomposition combustor 100, and when the ammonia decomposition reaction reaches a preset temperature, supply of nitrogen is stopped and then the cracker 130 can be supplied with ammonia from an external ammonia supplier.

In step S820, the cracker 13 can discharge reaction products including hydrogen, nitrogen, and non-reacted ammonia by decomposing ammonia.

In step S830, the adsorption refinement unit 300 can discharge intermediate refined products by separating or removing ammonia from the reaction products.

In step S840, the hydrogen separation membrane 400 can discharge a high-purity hydrogen product by refining high-purity hydrogen by separating and filtering the intermediate refined products. The high-purity hydrogen product discharged from the hydrogen separation membrane 400 can be supplied to the fuel cell (PEMFC or PAFC).

Further, impurities discharged from the hydrogen separation membrane 400 can be supplied back to and reused at the combustor 110. Accordingly, though not shown in figures, in step S850, the high-purity hydrogen product remaining after being used at the fuel cell 500 can be supplied back to and reused at the combustor 110. In this case, the supply amount of fuel gas that is supplied from the outside may be reduced or supply thereof may be stopped.

Next, referring to FIG. 9 to describe the production method for high purity hydrogen according to the second embodiment, in step S910, the assistant decomposition reaction unit 200 can perform heating by itself for ammonia decomposition reaction using an electric heating type.

In step S920, it is possible to determine whether the temperature of the assistant decomposition reaction unit 200 has reached a preset temperature. When the temperature of the assistant decomposition reaction unit 200 has not reached the preset temperature, the method goes back to step S910, and when the temperature of the assistant decomposition reaction unit 200 has reached the preset temperature, the method goes to step S930.

When the assistant decomposition reaction unit 200 reaches the preset temperature by self-heating, in step S930, the cracker 130 disposed at the front end of the assistant decomposition reaction unit 200 can be supplied with ammonia from an external ammonia supplier.

In step S940, the assistant decomposition reaction unit 200 can receive ammonia from the cracker 130, produce reaction products by decomposing the ammonia, and send the produced reaction products to the adsorption refinement unit 300.

In step S950, the adsorption refinement unit 300 can adsorb and refine the reaction products supplied from the assistant decomposition reaction unit 200. The adsorption refinement unit 300 can discharge hydrogen and nitrogen (intermediate refined products) remaining after ammonia is separated or removed by adsorbing and filtering the reaction products.

In step S960, the combustor 110 can perform combustion using hydrogen included in the intermediate refined products supplied from the adsorption refinement unit 300, and in step S970, the cracker 130 can be heated by combustion by the combustor 110.

In step S980, it is possible to determine whether the temperature of the cracker 130 has reached a preset temperature. When the temperature of the cracker 130 has not reached the preset temperature, the method goes back to step S970, and when the temperature of the cracker 130 has reached the preset temperature, the method goes to step S990.

In step S990, the cracker 130 can discharge reaction products including hydrogen, nitrogen, and non-reacted ammonia by decomposing ammonia supplied from the outside.

In step S1000, the adsorption refinement unit 300 can be supplied with the reaction products from the cracker 130 and can discharge intermediate refined products through an adsorption refinement process of separating or removing ammonia from the reaction products.

In step S1010, the hydrogen separation membrane 400 can discharge a high-purity hydrogen product by refining high-purity hydrogen by separating and filtering the intermediate refined products. The high-purity hydrogen product discharged from the hydrogen separation membrane 400 can be supplied to the fuel cell (PEMFC or PAFC). In this case, impurities discharged from the hydrogen separation membrane 400 can be supplied back to and reused at the combustor 110.

Accordingly, in step S1020, the high-purity hydrogen product remaining after being used at the fuel cell 500 can be supplied back to and reused at the combustor 110.

The production method for high purity hydrogen of the present disclosure described above is the same as or similar to the operation of the production apparatus for high purity hydrogen described with reference to FIG. 3 to FIG. 7, and the detailed description is thus omitted.

As described above, the production apparatus and method for high purity hydrogen using ammonia according to embodiments of the present disclosure may be operated in different ways depending on whether fuel gas such as LNG or LPG is used.

When fuel gas is used, it is possible to reduce discharge of nitrogen oxides (NOₓ) in the initial start step of the cracker 130 by preheating the cracker 130 until a steady state (e.g., 400 to 700° C.) is reached by burning the fuel gas, in comparison to the case of preheating using ammonia combustion reaction.

When fuel gas is not used, the assistant decomposition reaction unit 200 that uses an electric heating type supplies nitrogen and hydrogen, which are produced by decomposing ammonia, to the combustor 110 and the combustor 110 performs combustion using the supplied hydrogen, so it is possible to suppress discharge of nitrogen oxides even after the initial start step.

According to an embodiment of the present disclosure, it is possible to minimize use of fuel gas (LNG, LPG, etc.), produce high-purity hydrogen using ammonia, and suppress production of nitride oxides (NOₓ).

Further, it is possible to produce high-purity hydrogen using only ammonia even when it is difficult to use fuel gas.

The effects of the present disclosure are not limited thereto and it should be understood that the effects include all effects that can be inferred from the configuration of the present disclosure described in the following specification or claims.

The above description is provided as an exemplary embodiment of the present disclosure, and it should be understood that the present disclosure may be easily modified in other various ways without changing the spirit or the necessary features of the present disclosure by those skilled in the art. Therefore, the embodiments described above are only examples and should not be construed as being limitative in all respects. For example, the components described as single parts may be divided and the components described as separate parts may be integrated.

The scope of the present disclosure is defined by the following claims, and all of changes and modifications obtained from the meaning and range of claims and equivalent concepts should be construed as being included in the scope of the present disclosure.

What is claimed is:

1. A production apparatus for high purity hydrogen, comprising:
a decomposition reaction unit configured to decompose ammonia through ammonia decomposition reaction and discharge reaction products including hydrogen and nitrogen produced from the ammonia decomposition reaction and non-reacted ammonia;
an adsorption refinement unit configured to discharge intermediate refined products by separating or removing ammonia from the reaction products; and
a hydrogen separation membrane configured to discharge a high-purity hydrogen product by refining high-purity hydrogen by separating and filtering the intermediate refined products.

2. The production apparatus for high purity hydrogen of claim 1, wherein the decomposition reaction unit includes:
a cracker configured to be supplied with ammonia and discharge the reaction products by decomposing the supplied ammonia; and
a combustor configured to initially heat the cracker to a preset temperature using combustion heat generated by burning fuel gas or hydrogen.

3. The production apparatus for high purity hydrogen of claim 2, further comprising an assistant decomposition reaction unit disposed between the decomposition reaction unit and the adsorption refinement unit and configured to produce reaction products including hydrogen, nitrogen, and non-reacted ammonia by decomposing the ammonia supplied to the cracker using an electric heating type when fuel gas cannot be used.

4. The production apparatus for high purity hydrogen of claim 3, wherein the adsorption refinement unit supplies hydrogen and nitrogen remaining after separating or removing ammonia from the reaction products to the combustor, and
the combustor heats the cracker by performing combustion using the supplied hydrogen.

5. The production apparatus for high purity hydrogen of claim 3, wherein the adsorption refinement unit separates ammonia from the reaction products using an adsorption method, desorbs the separated ammonia, and supplies the desorbed ammonia to the decomposition reaction unit, and
the decomposition reaction unit produces reaction products by decomposing the ammonia supplied from the adsorption refinement unit through ammonia decomposition reaction.

6. The production apparatus for high purity hydrogen of claim 1, wherein the hydrogen separation membrane supplies a separated and refined high-purity hydrogen product to a fuel cell, and
the fuel cell is a polymer electrolyte membrane fuel cell (PEMFC) or a phosphoric acid fuel cell (PAFC).

7. The production apparatus for high purity hydrogen of claim 6, wherein the decomposition reaction unit receives and reuses a high-purity hydrogen product remaining after being used at the fuel cell.

8. The production apparatus for high purity hydrogen of claim 2, wherein the fuel gas is liquefied natural gas (LNG) or liquefied petroleum gas (LPG).

9. A production method for high purity hydrogen, comprising:
receiving and burning fuel gas by means of a combustor;
receiving ammonia and discharging reaction products including hydrogen, nitrogen, and non-reacted ammonia by decomposing the supplied ammonia through ammonia decomposition reaction by means of a cracker when the cracker reaches a target temperature due to heating by the combustor;
discharging intermediate refined products by separating or removing ammonia from the reaction products by means of an adsorption refinement unit; and
discharging a high-purity hydrogen product by refining high-purity hydrogen by separating and filtering the intermediate refined products by means of a hydrogen separation membrane.

10. The production method for high purity hydrogen of claim 9, wherein the target temperature is 400 to 700° C., and
when the cracker reaches the target temperature, supply of fuel gas from the combustor is stopped.

11. The production method for high purity hydrogen of claim 9, further comprising supplying a separated and refined high-purity hydrogen product to a fuel cell by means of the hydrogen separation membrane,
wherein the fuel cell is a polymer electrolyte membrane fuel cell (PEMFC) or a phosphoric acid fuel cell (PAFC).

12. The production method for high purity hydrogen of claim 11, further comprising receiving and reusing a high-purity hydrogen product remaining after used at the fuel cell by means of the cracker.

13. A production method for high purity hydrogen, comprising:
heating by means of an assistant decomposition reaction unit sing electricity;
supplying ammonia to a cracker when the assistant decomposition reaction unit reaches a preset temperature;
discharging reaction products including hydrogen, nitrogen, and non-reacting ammonia by receiving the ammonia supplied to the cracker and decomposing the supplied ammonia through ammonia decomposition reaction by means of the assistant decomposition reaction unit;
discharging intermediate refined products by separating or removing ammonia from the reaction products by means of an adsorption refinement unit; and
receiving the intermediate refined products and performing combustion using the intermediate refined products by means of a combustor.

14. The production method for high purity hydrogen of claim 13, further comprising:
discharging reaction products including hydrogen, nitrogen, and non-reacted ammonia by decomposing ammonia supplied from the outside by means of the cracker when the cracker reaches a preset temperature due to combustion by the combustor; and
discharging intermediate refined products by directly receiving the reaction products discharged from the cracker and by separating or removing ammonia by means of the adsorption refinement unit.

15. The production method for high purity hydrogen of claim 14, further comprising:
discharging a high-purity hydrogen product by refining high-purity hydrogen by separating and filtering the intermediate refined products discharged from the adsorption refinement unit by means of a hydrogen separation membrane; and
supplying a separated and refined high-purity hydrogen product to a fuel cell by means of the hydrogen separation membrane.
